(19) United States
(12) Patent Application Publication
(10) Pub. No.: US 2015/0109555 A1
(43) Pub. Date: Apr. 23, 2015

(54) Marine Display Device

(71) Applicant: Navico Holding AS, Egersund (NO)

(72) Inventor: Pablo Eynon, Auckland (NZ)

(21) Appl. No.: 14/136,183

(22) Filed: Dec. 20, 2013

Related U.S. Application Data
(60) Provisional application No. 61/894,002, filed on Oct. 22, 2013.

(51) Int. Cl. G02B 5/20; G02F 1/1333; G02F 1/13; G02F 1/1335

(52) U.S. Cl. CPC G02B 5/208; G02F 1/133509; G02F 1/133385; G02F 1/1313; G02F 1/1333
USPC 349/58; 359/350; 359/359; 29/595

(57) ABSTRACT

Various implementations described herein are directed to a marine display device. In one implementation, a marine display device may include a housing and a display panel disposed in the housing, where the display panel is configured to project one or more images relating to marine electronics data. The marine display device may also include an infrared filter coupled to the display panel and configured to block light from being applied to the display panel.

### CROSS-REFERENCE TO RELATED APPLICATIONS

This application claims the benefit of U.S. Provisional Patent Application Ser. No. 61/894,002, filed Oct. 22, 2013, titled COMPUTER DISPLAY, and the disclosure of which is incorporated herein by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of data, such as marine electronics data, may be displayed using a marine display device. Marine electronics data may include, for example, sonar data, chart data, radar data, or navigation data. In one scenario, the marine display device may be positioned on a vessel, such that the marine display device may be exposed to sunlight. In such a scenario, solar radiation may cause a thermal gain on one or more components of the marine display device.

### SUMMARY

Described herein are various implementations of a marine display device. In one implementation, a marine display device may include a housing and a display panel disposed in the housing, where the display panel is configured to project one or more images relating to marine electronics data. The marine display device may also include an infrared filter coupled to the display panel and configured to block light from being applied to the display panel.

In another implementation, a method may include providing a housing and positioning a display panel in the housing, where the display panel is configured to project an image relating to marine electronics data. The method may also include coupling an infrared filter to the display panel, where the infrared filter is configured to block light from being applied to the display panel.

In yet another implementation, a marine electronics device may include a housing and a computing system disposed in the housing. The marine electronics device may also include a marine display device disposed in the housing. The marine display device may include a display panel configured to project one or more images relating to marine electronics data received from the computing system. The marine display device may also include an infrared filter coupled to the display panel and configured to block light from being applied to the display panel.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a diagram of marine display device in accordance with implementations of various techniques described herein.

FIG. 2 illustrates a schematic diagram of a marine electronics device having a computing system in accordance with implementations of various techniques described herein.

FIG. 3 illustrates a schematic diagram of a multi-function display (MFD) unit in accordance with implementations of various techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

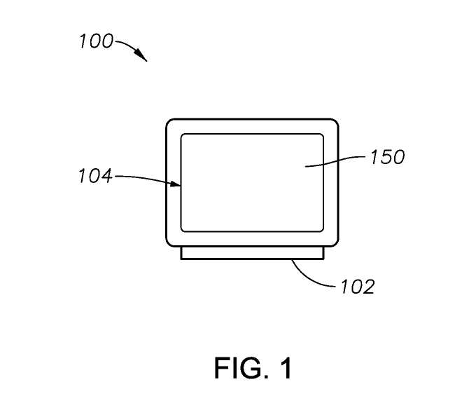

Various implementations of a marine display device will now be described in more detail with reference to FIGS. 1-3.

### Marine Display Device

A vessel traversing through water may use equipment to assist an operator of the vessel with navigation and other functions. The vessel may be a surface water vehicle, a submersible water vehicle, or any other implementation known to those skilled in the art. The equipment may include a marine display device disposed on board the vessel.

The marine display device may be a liquid crystal display (LCD) device, a plasma display device, a light-emitting diode (LED) display device, or any other implementation known to those skilled in the art. In one implementation, the marine display device may be used to display one or more images relating to one or more types of marine electronics data to the operator. Marine electronics data may include chart data, sonar data, structure data, radar data, navigation data, or any other type known to those skilled in the art.

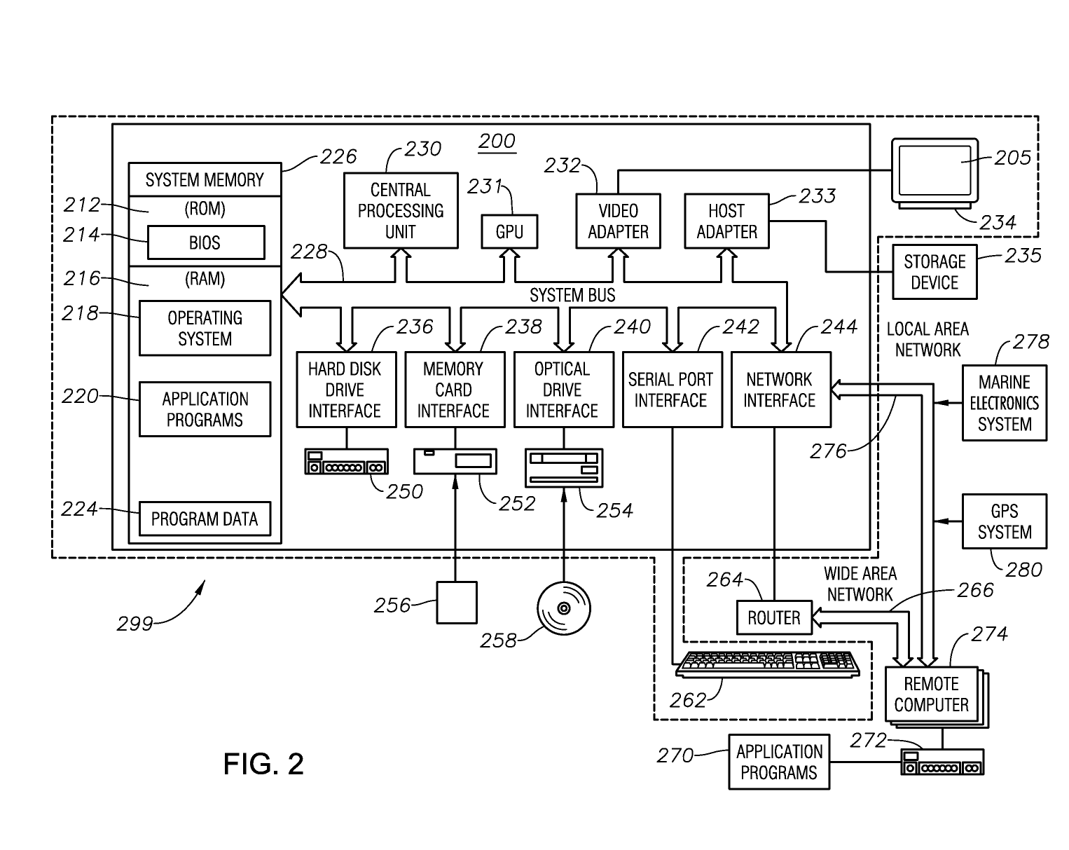

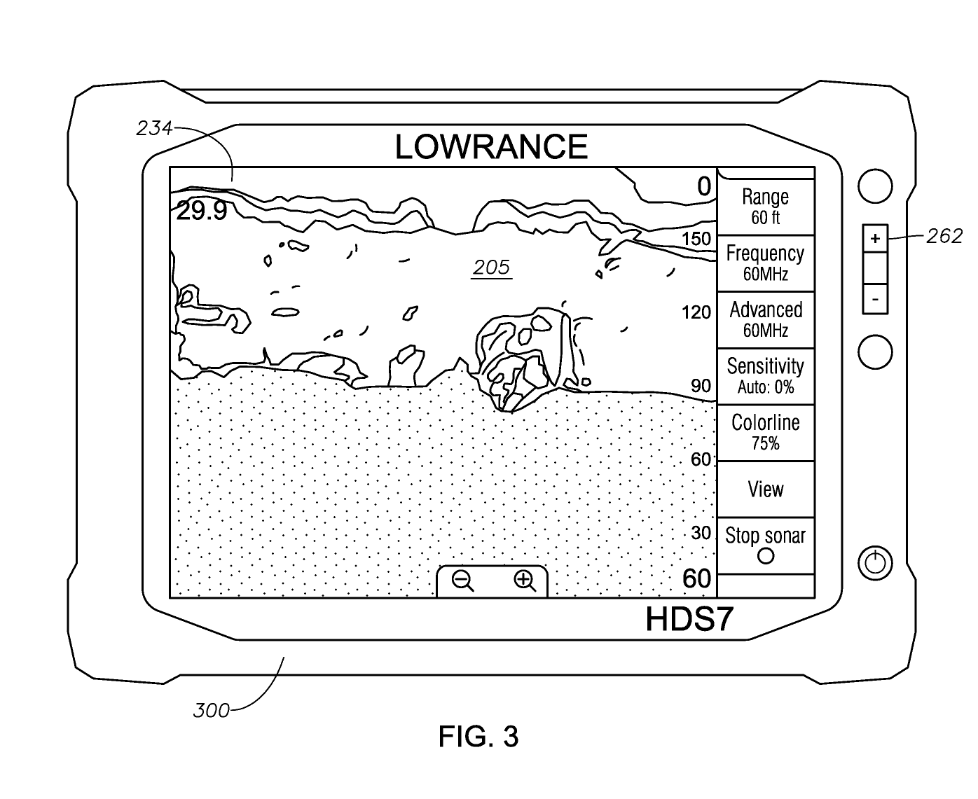

In another implementation, the marine display device may be used in conjunction with a marine electronics device also disposed on board the vessel. The marine electronics device may be any computing implementation known to those skilled in the art, and is further described below with respect to FIG. 2. In such an implementation, the marine display device may show marine electronics data that has been processed by the marine electronics device. The marine display device may also display a user interface for software modules stored on the marine electronics device, such as an operating system used to access the marine electronics data. In a further implementation, the marine display device may be disposed within a housing of the marine electronics device. In such an implementation, the marine electronics device may be a multi-function display (MFD) unit, as is described below with respect to FIG. 3.

FIG. 1 illustrates a diagram of marine display device 100 in accordance with implementations of various techniques described herein. The marine display device 100 may include a housing 102 and a display panel 104 disposed within the housing 102. The display panel 104 may be used to project the one or more images relating to marine electronics data. The housing 102 may be composed of plastic or any other implementation known to those skilled in the art.

In one implementation, and as mentioned above, the marine display device 100 may be an LCD device. In such an implementation, the display panel 104 may be an LCD panel, where the LCD panel may include a plurality of pixels used to display the images. In particular, and as is known in the art, each pixel (not illustrated) of the LCD panel may include a layer of liquid crystal disposed between two transparent electrodes and two polarizing filters. In some implementations, the LCD device may include a backlight unit (not illustrated) also disposed within the housing 102. The backlight unit may emit a light to each pixel of the LCD panel. In particular, the LCD panel may project the images by allowing light from the backlight unit to pass through some pixels, while also blocking light from passing through other pixels. The backlight unit may include at least one LED.

In another implementation, the marine display device 100 may be a thin-film-transistor (TFT) LCD device. In such an implementation, the display panel 104 may be an LCD panel with a glass panel optically bonded to the LCD panel. In particular, the glass panel may be applied to a front portion of the LCD panel. The front portion of the LCD panel may be a portion of the LCD panel 104 that is generally exposed to an exterior environment of the marine display device 100 and that also displays images to the operator.

As also mentioned above, the marine display device 100 may be a plasma display device. In such an implementation, the display panel 104 may be a plasma display panel, where the plasma display panel may include a plurality of cells used to display the images. In particular, and is known in the art, each cell (not illustrated) of the plasma display panel may include a mixture of gases and/or plasma disposed between two panels of glass. In such an implementation, each cell may emit a glow discharge upon an application of electricity to the cell.

### Infrared Filter

While disposed on board the vessel, the marine display device 100 may be exposed to sunlight. In such a scenario, solar radiation from the sunlight may cause a thermal gain on one or more components of the marine display device 100, such as the display panel 104.

For example, sunlight on an LCD device may cause liquid crystals of its LCD panel to be heated by the solar radiation, either through direct contact with the sunlight or by increasing an internal temperature of the housing 102. The liquid crystals may then experience thermal gain to the point where its temperature may meet or exceed a maximum operating temperature for the liquid crystals. Once the maximum operating temperature has been met or exceeded, the LCD device may experience “black out,” where images on the LCD panel may no longer be visible or may become unclear. Further, as the size of the marine display device 100 increases, the amount of thermal gain experienced by components, such as the display panel 104, may also increase. Consequently, the marine display device 100 may then have a higher likelihood of experiencing effects such as “black out.”

To mitigate such effects of the sunlight, the marine display device 100 may utilize an infrared filter 150. In one implementation, and as illustrated in FIG. 1, the infrared filter 150 may be applied to the display panel 104. As example, the infrared filter 150 may be applied to a front portion of the display panel 104. As similarly described above with respect to the LCD panel, the front portion of the display panel 104 may be a portion of the display panel 104 that is generally exposed to an exterior environment of the marine display device 100 and that also displays images to the operator. In one such implementation, for an LCD device, the front portion of the LCD panel may be composed of a polarizing filter and the infrared filter 150 may be applied to the polarizing filter.

In another implementation, for a TFT LCD device, the infrared filter 150 may be applied to a front portion of the glass panel that is generally exposed to an exterior environment of the marine display device 100. In yet another implementation, for a TFT LCD device, the infrared filter 150 may be applied to a back portion of the glass panel that is generally unexposed to the exterior environment of the marine display device 100.

The infrared filter 150 may block light, such as infrared and/or near-infrared light, from being directly applied to the display panel 104. In one implementation, the infrared filter 150 may block the infrared and/or near-infrared light by absorbing and/or reflecting such light. The infrared filter 150 may block about 20-50% of infrared and/or near-infrared light from passing through the filter and being applied to the display panel 104. In another implementation, the infrared filter 150 may block light having wavelengths ranging from about 700 nanometers (nm) to about 1200 nm. In a further implementation, the infrared filter 150 may block light having a wavelength of at least 800 nm, which may avoid producing an appearance of a red tinge on the display panel 104 to the operator.

In one implementation, the infrared filter 150 may be a film that is applied to the display panel 104. In such an implementation, the infrared filter 150 may be layered onto a generally transparent film or may itself be a generally transparent film. When in the form of a film, the infrared filter 150 may be composed of plastic and/or any other material known to those skilled in the art. Further, in such an implementation, the infrared filter 150 may be coupled to the display panel 104 through an adhesive, a bonding agent, or any other implementation known to those skilled in the art.

In another implementation, the infrared filter 150 may be a coating that is applied to the display panel 104. In such an implementation, the infrared filter 150 may be generally transparent, and may be composed of tin oxide or any other implementation known to those skilled in the art. Further, in such an implementation, the infrared filter 150 may be applied to the display panel 104 through dip coating, spray coating, or any other method known to those skilled in the art. For example, the infrared filter 150 may be applied as a coating using one or more processes of vacuum deposition, such as through physical vapor deposition.

In a further implementation, multiple films or coatings of the infrared filter 150 may be applied to the display panel 104. In such an implementation, the infrared filter 150 may affect the illumination of images projected on the display panel 104 to the operator. Accordingly, the number of films or coatings used for the infrared filter 150 may depend on a desired illumination of the images. In another implementation, for an LCD device, the number of films or coatings of the infrared filter 150 used may depend on the ability of a backlight unit to provide the desired illumination.

In yet another implementation, the infrared filter 150 may be used on the display panel 104 in conjunction with anti-fingerprint (AF) coatings, referred to as hydrophobic or oleophobic coatings. In such an implementation, the AF coatings may be applied onto a front portion of the infrared filter 150 that is generally exposed to the exterior environment of the marine display device 100.

In sum, implementations of the marine display device 100, described above with respect to FIG. 1, may be used on a vessel in areas prone to direct sunlight, such as on an exposed flybridge. The infrared filter 150 may reduce effects of the sunlight, such as “black out,” by reducing an amount of infrared and/or near-infrared light being directly applied to the display panel 104. In particular, the infrared filter 150 may reduce a thermal gain on one or more components of the marine display device 100, such as the display panel 104. The infrared filter 150 may also mitigate an increase in temperature in the housing 102 caused by the sunlight.

In addition, the use of the infrared filter 150 may help to avoid the use of more expensive marine display devices having higher operating temperatures, particularly those having larger sized display panels. Further, various heat management techniques in the housing 102 may be used in conjunction with the infrared filter 150 to reduce the temperature in the housing. Such techniques may include the use of one or more heat sinks, fans, and/or any other implementations known to those skilled in the art. Moreover, the use of the infrared filter 150 may allow for greater illumination of images projected from the display panel 104 in areas with direct sunlight.

### Marine Electronics Device

As mentioned above, the marine display device 100 may be used in conjunction with a marine electronics device also disposed on board the vessel. The marine electronics device may be any computing implementation known to those skilled in the art, including an MFD unit, as further described below.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

FIG. 2 illustrates a schematic diagram of a marine electronics device 299 having a computing system 200 in accordance with implementations of various techniques described herein. The marine electronics device 299 may be any type of electrical and/or electronics device capable of processing data via the computing system 200. In one implementation, the marine electronics device 299 may be a marine instrument, such that the marine electronics device 299 may use the computing system 200 to display and/or process one or more types of marine electronics data, such as chart data, sonar data, structure data, radar data, navigation data, or any other type known to those skilled in the art. In a further implementation, the marine electronics device 299 may be an MFD unit, such that the marine electronics device 299 may be capable of displaying and/or processing multiple types of marine electronics data.

The computing system 200 may be a conventional desktop, a handheld device, personal digital assistant, a server computer, electronic device/instrument, laptop, tablet, or part of a navigation system, marine electronics, or sonar system. It should be noted, however, that other computer system configurations may be used. The computing system 200 may include a central processing unit (CPU) 230, a system memory 226, a graphics processing unit (GPU) 231 and a system bus 228 that couples various system components including the system memory 226 to the CPU 230. Although only one CPU 230 is illustrated in FIG. 2, it should be understood that in some implementations the computing system 200 may include more than one CPU 230.

The CPU 230 may include a microprocessor, a microcontroller, a processor, a programmable integrated circuit, or a combination thereof. The CPU 230 can comprise an off-the-shelf processor such as a Reduced Instruction Set Computer (RISC), or a Microprocessor without Interlocked Pipeline Stages (MIPS) processor, or a combination thereof. The CPU 230 may also include a proprietary processor.

The GPU 231 may be a microprocessor specifically designed to manipulate and implement computer graphics. The CPU 230 may offload work to the GPU 231. The GPU 231 may have its own graphics memory, and/or may have access to a portion of the system memory 226. As with the CPU 230, the GPU 231 may include one or more processing units, and each processing unit may include one or more cores.

The CPU 230 may provide output data to a GPU 231. The GPU 231 may generate graphical user interfaces that present the output data. The GPU 231 may also provide objects, such as menus, in the graphical user interface. A user may provide inputs by interacting with the objects. The GPU 231 may receive the inputs from interaction with the objects and provide the inputs to the CPU 230. A video adapter 232 may be provided to convert graphical data into signals for a marine display device 234. The marine display device 234 includes a display panel 205. The display panel 205 can be sensitive to heat or touching (now collectively referred to as a “touch screen”).

The system bus 228 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 226 may include a read only memory (ROM) 212 and a random access memory (RAM) 216. A basic input/output system (BIOS) 214, containing the basic routines that help transfer information between elements within the computing system 200, such as during start-up, may be stored in the ROM 212.

The computing system 200 may further include a hard disk drive interface 236 for reading from and writing to a hard disk 250, a memory card reader 252 for reading from and writing to a removable memory card 256, and an optical disk drive 254 for reading from and writing to a removable optical disk 258, such as a CD ROM or other optical media. The hard disk 250, the memory card reader 252, and the optical disk drive 254 may be connected to the system bus 228 by a hard disk drive interface 236, a memory card reader interface 238, and an optical drive interface 240, respectively. The drives and their associated computer-readable media may provide nonvolatile storage of computer-readable instructions, data structures, program modules and other data for the computing system 200.

Although the computing system 200 is described herein as having a hard disk, a removable memory card 256 and a removable optical disk 258, it should be appreciated by those skilled in the art that the computing system 200 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 200. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 200 may also include a host adapter 233 that connects to a storage device 235 via a small computer system interface (SCSI) bus, a Fiber Channel bus, an eSATA bus, or using any other applicable computer bus interface. The computing system 200 can also be connected to a router 264 to establish a wide area network (WAN) 266 with one or more remote computers 274. The router 264 may be connected to the system bus 228 via a network interface 244. The remote computers 274 can also include hard disks 272 that store application programs 270.

In another implementation, the computing system 200 may also connect to one or more remote computers 274 via local area network (LAN) 276 or the WAN 266. When using a LAN networking environment, the computing system 200 may be connected to the LAN 276 through the network interface or adapter 244. The LAN 276 may be implemented via a wired connection or a wireless connection. The LAN 276 may be implemented using Wi-Fi technology, cellular technology, or any other implementation known to those skilled in the art. The network interface 244 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 274. It will be appreciated that the network connections shown are exemplary and other means of establishing a communications link between the computer systems may be used.

A number of program modules may be stored on the hard disk 250, memory card 256, optical disk 258, ROM 212 or RAM 216, including an operating system 218, one or more application programs 220, and program data 224. In certain implementations, the hard disk 250 may store a database system. The database system could include, for example, recorded points. The application programs 220 may include various mobile applications (“apps”) and other applications configured to perform various methods and techniques described herein. The operating system 218 may be any suitable operating system that may control the operation of a networked personal or server computer.

A user may enter commands and information into the computing system 200 through input devices such as buttons 262. Other input devices may include a microphone (not shown). These and other input devices may be connected to the CPU 230 through a serial port interface 242 coupled to system bus 228, but may be connected by other interfaces, such as a parallel port, game port or a universal serial bus (USB).

Certain implementations may be configured to be connected to a GPS system 280, and/or a marine electronics system 278. The GPS system 280, and/or marine electronics system 278 may be connected via the network interface 244. The marine electronics system 278 may include one or more components disposed at various locations on the vessel. In particular, the marine electronics system 278 may include one or more marine electronics data modules, sensors, instrumentation, and/or any other devices known to those skilled in the art which may transmit marine electronics data to the marine electronics device 299 for processing and/or display. The marine electronics data transmitted to the marine electronics device 299 may include chart data, sonar data, structure data, radar data, navigation data, or any other type known to those skilled in the art. For example, the marine electronics system 278 may include a paddlewheel sensor, a compass heading sensor, and the like. In such an example, the paddlewheel sensor may transmit speed data and the compass heading sensor may transmit heading data to the marine electronics device 299.

As mentioned above, the marine display device may be disposed within a housing of the marine electronics device. In particular, the computing system 200, the marine display device 234, the display panel 205, and the buttons 262 may be integrated into a console, such as an MFD unit 300. FIG. 3 illustrates a schematic diagram of an MFD unit 300 in accordance with implementations of various techniques described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A marine display device, comprising:
a housing;
a display panel disposed in the housing and configured to project one or more images relating to marine electronics data; and
an infrared filter coupled to the display panel and configured to block light from being applied to the display panel.

2. The marine display device of claim 1, wherein the display panel is a liquid crystal display (LCD) panel.

3. The marine display device of claim 1, wherein the infrared filter is coupled to a front portion of the display panel configured to project the one or more images.

4. The marine display device of claim 1, wherein the infrared filter comprises one or more coatings applied to the display panel.

5. The marine display device of claim 1, wherein the infrared filter comprises one or more films applied to the display panel.

6. The marine display device of claim 1, wherein the infrared filter is configured to block infrared and near-infrared light.

7. The marine display device of claim 1, wherein the infrared filter is configured to block light having wavelengths ranging from about 700 nanometers (nm) to about 1200 nm.

8. The marine display device of claim 1, wherein the infrared filter is configured to reflect infrared light, absorb infrared light, or combinations thereof.

9. The marine display device of claim 1, further comprising a heat sink, a fan, or combinations thereof disposed in the housing.

10. A method, comprising:
providing a housing;
positioning a display panel in the housing, wherein the display panel is configured to project one or more images relating to marine electronics data; and
coupling an infrared filter to the display panel, wherein the infrared filter is configured to block light from being applied to the display panel.

11. The method of claim 10, wherein the display panel is a thin-film-transistor (TFT) liquid crystal display (LCD) panel.

12. The method of claim 10, wherein the infrared filter is coupled to a front portion of the display panel.

13. The method of claim 10, wherein coupling the infrared filter to the display panel comprises applying one or more coatings to the display panel.

14. The method of claim 10, wherein coupling the infrared filter to the display panel comprises applying one or more films to the display panel.

15. The method of claim 10, wherein the infrared filter is configured to block infrared and near-infrared light.

16. The method of claim 10, wherein the infrared filter is configured to block light having wavelengths ranging from about 700 nanometers (nm) to about 1200 nm.

17. A marine electronics device, comprising:
a housing;
a computing system disposed in the housing; and
a marine display device disposed in the housing, comprising:
a display panel configured to project one or more images relating to marine electronics data received from the computing system; and
an infrared filter coupled to the display panel and configured to block light from being applied to the display panel.

18. The marine electronics device of claim 17, wherein the infrared filter comprises one or more coatings applied to the display panel.

19. The marine electronics device of claim 17, wherein the infrared filter comprises one or more films applied to the display panel.

20. The marine electronics device of claim 17, wherein the infrared filter blocks light having wavelengths ranging from about 700 nanometers (nm) to about 1200 nm.
